(19) United States
(12) Patent Application Publication
(10) Pub. No.: US 2009/0313300 A1
(43) Pub. Date: Dec. 17, 2009

(54) METHOD, COMPUTER PROGRAM PRODUCT AND SYSTEM FOR DYNAMICALLY DETERMINING ACTIONS ASSOCIATED TO OPERATIONS ON RICH MEDIA OBJECTS

(75) Inventors: Paolo Dettori, Hartsdale, NY (US); Julio Nogima, Tarrytown, NY (US); Frank A. Schaffa, Hartsdale, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/140,642

(22) Filed: Jun. 17, 2008

(51) Int. Cl. G06F 7/00

(52) U.S. Cl. 707/103 Y; 707/E17.009

(57) ABSTRACT

Utilizing a service oriented architecture middleware to allow services to process media, the method including dynamically defining one or more media properties and operations available to a service, generating a media object with selected properties and operations, communicating the media object to the services, dynamically defining an action associated to an operation in response to an operation request from the service, implementing the action and communicating the result of the action to the service.

### BACKGROUND OF THE INVENTION

The invention relates to computer systems. More specifically, the invention relates to rich media applications handling media objects in order to allow actions associated to an operation on a media object to be determined dynamically.

A rich media object can be represented as an entity with properties and operations. The properties describe the specifics of the media, whereas the operations allow users to search access and transform the media. The Moving Picture Experts Group (MPEG) has developed an evolving set of standards for video and audio compression and for multimedia delivery. A standard known as MPEG-21 provides a larger, architectural framework for the creation and delivery of multimedia. MPEG-21 defines several key elements, including digital item identification and declaration, content handling and usage, intellectual property management and protection, terminals and networks, content representation, and event reporting. More specifically, the MPEG-21 initiative defines a Digital Item as an object to describe a digital object. MPEG-21 standardizes the manner in which resources and metadata associated to a digital object are represented (MPEG-21 DID). MPEG-21 also proposes a way to process this digital object by standardizing how to represent one or more operations on the object (MPEG-21 DIP).

An operation usually implies an action or a sequence of actions involving an object. An example of an action could be to download a media object. Another example would be to first transcode a media object to a more appropriate format for the user, and then download the transcoded media object. In both examples, the operation at the object level could be defined simply as “download”. The step of transcoding the media object when the object is downloaded could be completely transparent for the user of the object.

The actions associated to an operation may be defined statically or, alternatively, may be dependent on one or more variables. For example, a property of the media could be implemented as a variable. There are already solutions that addresses the particular case where the action to be taken depends on some properties of the media (e.g. format or size). Other important variables for defining the action are the context in which the object is being used and the media client itself.

The techniques disclosed herein address the usage of media objects in a service oriented architecture (SOA) framework. In an SOA environment, there may be a number of services that deals with media objects. These services may be connected through a service oriented architecture (SOA) middleware to offer a complete solution to a user or customer. Oftentimes, these services are linked together to create a workflow where a media object is received by one service, processed and sent to the next service in the chain. In this scenario, the individual services do not know (and do not need to know) the identities of any predecessor and successor services. The chaining information is maintained and controlled by middleware.

In an SOA environment, the action associated to an operation on the media can be dependent on the workflow. A simple solution to accomplish this functionality would be to store in the media object some state information so that each one of the services called would have information about the workflow up to the moment that the service is called. This approach would not be very practical since each one of the services involved would need to understand the information about a specific workflow in order to interpret the state information. If one considers that new services can always be added and the workflow can be always changed, such a solution would easily lead to a huge effort at the service end to determine the context in which the service is being called, with a chance that this determination would not even be possible in some cases.

In view of the foregoing considerations, what is needed is a technique for dynamically defining the media properties and operations exposed to a particular service, such that only suitable and authorized properties and operations are made available to the service. And furthermore to define the action associated to an operation dynamically.

### SUMMARY OF THE INVENTION

A method for utilizing a service oriented architecture middleware to allow services to process media, the method including dynamically defining one or more media properties and operations available to a service, generating a media object with selected properties and operations, communicating the media object to the services, dynamically defining an action associated to an operation in response to an operation request from the service, implementing the action and communicating the result of the action to the service.

A system and a computer program product corresponding to the above-summarized method is also described and claimed herein. Other methods, systems, and/or computer program products according to embodiments will be or become apparent to one with skill in the art upon review of the following drawings and detailed description. It is intended that all such additional methods, systems, and/or computer program products be included within this description, be within the scope of the present invention, and be protected by the accompanying claims.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

Referring now to the drawings wherein like elements are numbered alike in the several FIGURES:

FIG. 1 is a flowchart setting forth one illustrative method for utilizing a service oriented architecture middleware to allow a service to process a media by creating a media object that exposes properties and operations to the service; and to define and implement the action associated to each one of the operations.

FIG. 2 is a data structure diagram showing an illustrative complex media object (CMO).

FIG. 3 is a flow diagram showing a transcoding operation being called on a CMO by a first service.

FIG. 4 is a flow diagram showing the transcoding operation of FIG. 3 being called on the CMO of FIG. 3 by a second service.

FIG. 5 is an illustrative block architectural diagram showing the components of the invention.

FIG. 6 is a flow diagram showing the utilization of a CMO in an exemplary workflow.

FIG. 7 is a flow diagram illustrating an exemplary method for creating a CMO.

The detailed description explains the preferred embodiments of the invention, together with advantages and features, by way of example with reference to the drawings.

### DETAILED DESCRIPTION

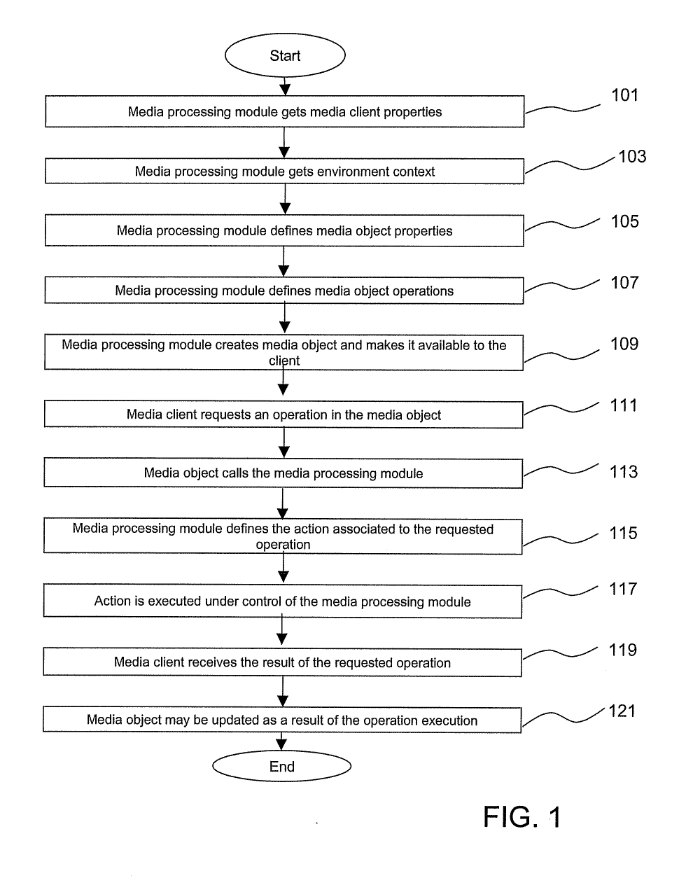

FIG. 1 is a flowchart setting forth one illustrative method for utilizing a service oriented architecture middleware to allow services for calling operations on a media object.

The procedure commences at block 101 where a media processing module retrieves information regarding to the client application. The client properties include a unique identifier used by the media processing module to address the particular client. Other properties include characteristics of the client such as: supported type of media (e.g. audio, video, images, text), supported media formats (e.g. Quicktime, MPEG4, Windows Media), supported transport protocol (e.g. HTTP, FTP, File), supported bit rates and resolutions.

At block 103 the media processing module retrieves the context regarding to the environment wherein the client receives the media for processing. The context provides information about the state of this environment. If the client is part of a workflow the context provides information about the workflow execution up to the point where the client is called. Context may include information such as time and geographical location of the client. Information about the various processes the specific media went through and the sub-products of these processes is also part of the context. Additional context information may be provided in the form of business rules.

Next at block 105 the media processing module defines the properties to be exposed by the media object to the media client, based on the media client properties and the context. These are properties that are suitable to the particular media client and for which the media client has authorized access. At block 107 the media processing module defines the operations to be exposed by the media object to the media client, based on the media client properties and the context. These are operations that are suitable to the particular media client and for which the media client has authorized access.

The procedure continues at block 109 where the media processing module creates a media object with the defined properties and operations and makes it available to the media client. Next at block 111, as part of the media processing performed by the media client it requests an operation in the media object. At block 113 the media object runtime on the client performs a call to the media processing module passing the requested operation.

Then at block 115 the media processing module defines the action associated to the requested operation, based on the media client properties and the context. Block 117 corresponds to the execution of the action. The media processing module is responsible for the execution of the action but not necessarily for the implementation of the action. The action may be implemented by other applications that are accessible by the media processing module. Then at block 119 the media processing module send the result of the action to the media object runtime which in turn communicates the result to the media client.

Block 121 shows that the media object properties may be updated as a result of the operation. For example if the requested operation creates a new representation (as a result of a transcoding operation) the media object may be updated with the new representation.

The procedure of FIG. 1 may be performed, for example, in conjunction with a service oriented architecture (SOA) middleware, media services and a container to process media objects (CMOs). A SOA middleware can act as a media processing module and media services are clients for the media objects. In this invention a media object is referred to as Complex Media Object (CMO).

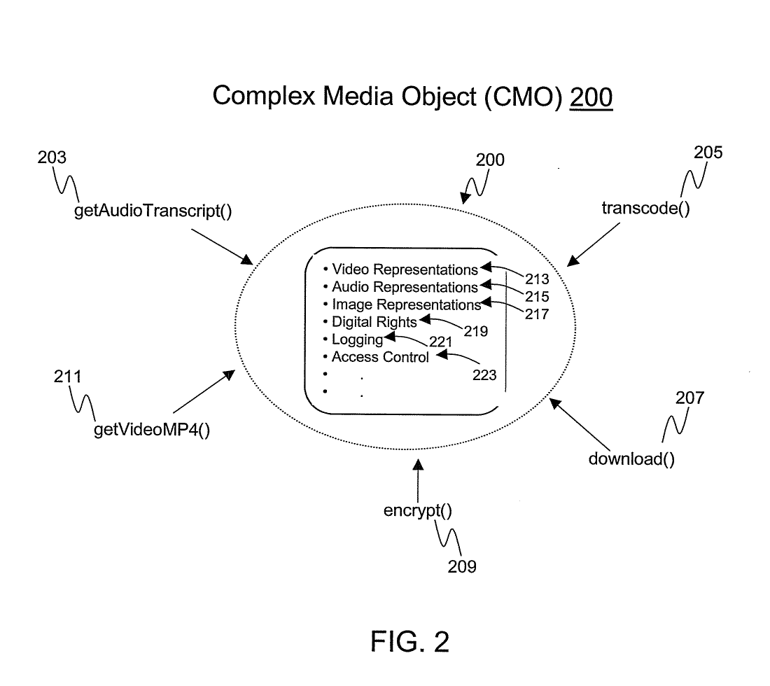

FIG. 2 is a data structure diagram showing an illustrative Complex Media Object (CMO) 200. The CMO 200 contains properties and operations supported by a media object. Media in this context is not represented by a specific file or URL but, rather, the CMO includes different media representations of content, all metadata for the content, and all sub-products created by transformation processes on the media. A CMO can contain multiple representations of each one of content types, such as audio representations 215, video representations 213, and image representations 217. For example, the CMO may contain several video representations 213 of video content: high-resolution MPEG-4, Quicktime, and Windows Media, by way of illustration.

Pursuant to the procedure of FIG. 1, media objects are processed by one or more services as CMOs. The CMOs expose properties and operations that can be called by the services. The implementation of these operations may involve calling other services that are accessible by the middleware and in certain cases a execution of a business process that involves orchestration of services. Some examples of CMO properties are: different representations (formats, resolutions, localization) of each type of content (audio, video, images, text, captioning, etc), metadata for each representation, transformation/processing logging 221, digital rights 219, and access control 223. Examples of CMO operations can be: format/resolution transcoding such as transcode( ) 205, data persistence, content analytics, content rendering, data encryption such as encrypt( ) 209, download such as download( ) 207, and partial retrieval of the content (time and space) such as getAudioTranscript( ) 203 and getVideoMP4( ) 211.

These properties and operations are dynamically defined when the CMO is passed to a service. The CMO middleware is the entity responsible for defining the operations and properties available to a service. The CMO middleware is part of a service oriented architecture middleware. The CMO may use a number of variables to define these operations and properties. For example, the definition can depend on the identity of the service to which the CMO is being handed. In a SOA scenario, this service may be called as part of a workflow. The definition then may take into consideration factors associated to a workflow such as the sequence in which the services are called. Other factors may include time and geographical location of the service.

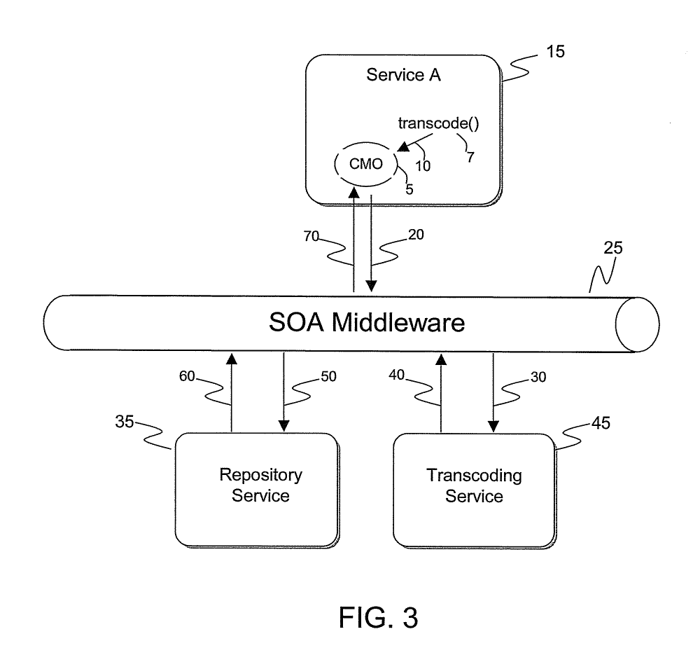

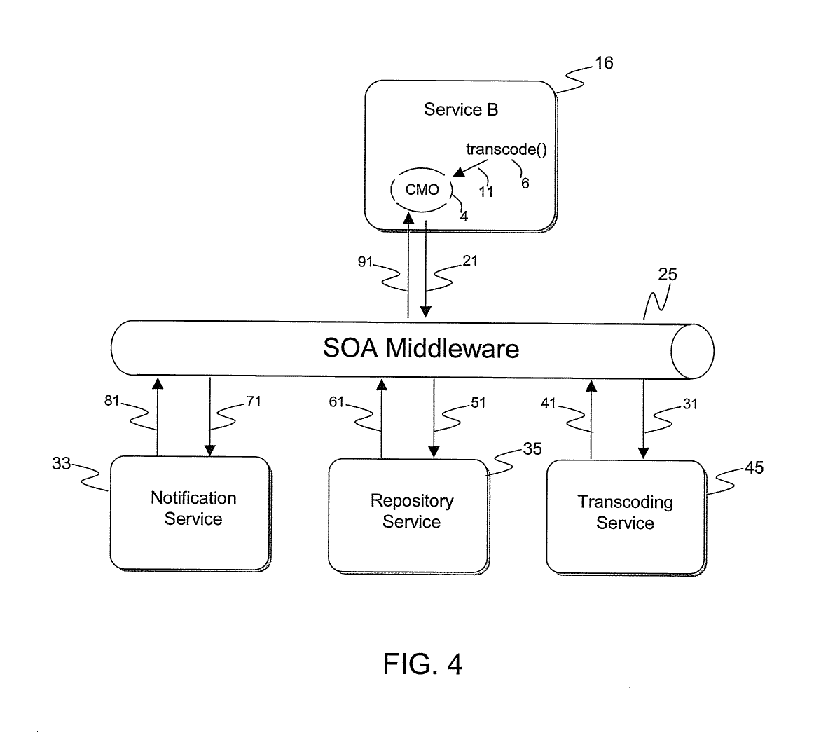

When a service is called, it receives a CMO with properties and operations defined by middleware. The action associated to each one of the operations is also defined by the middleware and can be modified dynamically at runtime. FIG. 3 is a data flow diagram showing a transcoding operation being called on a CMO by a first service, and FIG. 4 is a data flow diagram showing the transcoding operation of FIG. 3 being called on the CMO of FIG. 3 by a second service. FIGS. 3 and 4 illustrate how the same operation on the same media object can lead to two different actions when two distinct services are using the objects. The same service can also be called twice in a workflow using the same CMO and the action associated to a CMO operation may be different for each one of the calls. In the last scenario the middleware may select distinct actions since it understands the context where the service is called in the workflow. In addition, the middleware keeps track of media transformations and if a particular media transformation request was already performed there is the possibility of reuse the result, i.e. the middleware would not need to call the transformation service (e.g. transcoder) again.

Referring now to FIG. 3, at step 10, a first service denoted as service A 15 calls the transcode( ) 7 operation available in the CMO 5. Next, at step 20 (FIG. 3), the CMO issues a request to a middleware 25 indicating that the transcode( ) 7 operation was called by the first service on the CMO. The operation is then mapped into a sequence of actions by the middleware 25. At step 30, a transcoding service is called by the middleware 25 as part of an action defined by the middleware for the particular operation called on the CMO. At step 40, execution of the transcoding is completed.

A repository service 35 is then called by the middleware 25 to store content created by the transcoding service at step 50. Next, at step 60, the repository service 35 execution is completed. The middleware 25 returns to the CMO to indicate that the transcode( ) 7 operation is complete at step 70. The CMO may be updated in case the operation results in changing of any of its properties.

Referring now to FIG. 4, at step 11, a second service denoted as service B 16 calls the transcode( ) 6 operation available in the CMO 4. Next, at step 21 (FIG. 4), the CMO issues a request to a middleware 25 indicating that the transcode( ) 6 operation was called by the second service on the CMO. The operation is then mapped into a sequence of actions by the middleware 25. At step 31, a transcoding service is called by the middleware 25 as part of an action defined by middleware for the particular operation called on the CMO. At step 41, execution of the transcoding is completed.

A repository service 35 is then called by the middleware 25 to store content created by the transcoding service at step 51. Next, at step 61, the repository service 35 execution is completed. A notification service 33 is called next by the middleware 25 to request a notification to be sent to a creator of content informing that a new representation of the content was created (step 71). The notification service 33 execution is completed at step 81. The middleware 25 returns to the CMO to indicate that the transcode( ) 6 operation is complete at step 91. The CMO may be updated in case the operation results in changing of any of its properties.

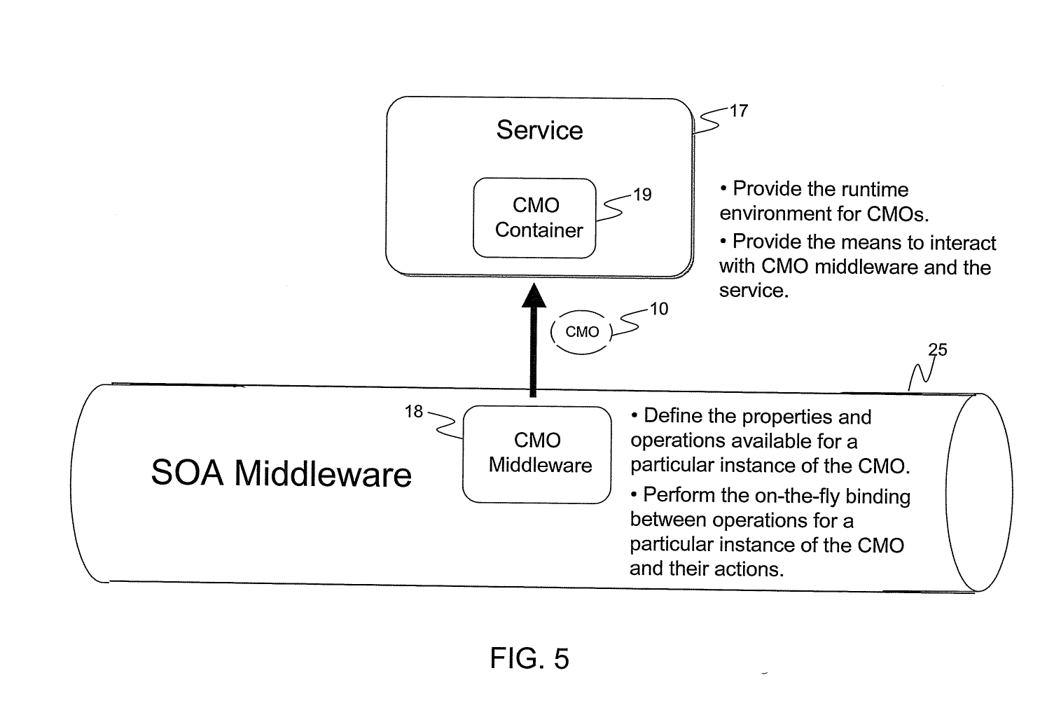

FIG. 5 is an illustrative block architectural diagram of a service oriented architecture middleware 25, a service 17 and a CMO 10. The middleware 25 is equipped with a CMO middleware 18. The CMO middleware 18 defines the properties and operations available for a particular instance of the CMO 10. A CMO container 19, deployed at service 17, provides a mechanism for the CMO 10 to interact with the CMO middleware 18. The CMO container 19 also provides a mechanism for the CMO 10 to interact with the service 17. The CMO container 19 provides to the service 17 access to the properties and operations available at the CMO 10. The CMO container 19 interacts with the CMO middleware 18 to execute the appropriate actions when a CMO operation is requested by the service 17.

The CMO container 19 provides a runtime environment for the CMO 10. The CMO container 19 inspects the CMO 10 for available properties and makes these properties available to the service 17. The CMO container 19 inspects the CMO 10 for available operations and makes these operations available to the service 17. The CMO container 19 implements the logic necessary to perform the available operations by either running a local code or making calls to the CMO middleware 18.

The CMO middleware 18 defines the actions associated to each one of the operations. This association consists in mapping each one of the operations to process or sequence of processes that are registered with the middleware 25. A process can be a method (or function) provided by a service accessible by the middleware. A sequence of processes can be a workflow built with methods provided by services accessible by the middleware. The actions can be pre-defined or defined on-the-fly (to include some parameters that can be only available at runtime).

The determination of the properties to be exposed to a service is dependent on the characteristics of the service. For example, a media may contain a number of different representations for video (different formats and bit rates). A particular service may be able to handle only a subset of these representations and does not need to know about representations that it cannot handle. So when the CMO 10 for that service is created, it will only contain the supported representations.

Certain properties of the media may also be kept private and not be available for all services in a workflow. An example could be the production cost of a particular media. For security purposes, certain services should only receive encrypted content so the CMO 10 should not provide any representation of the content in the open.

The service oriented architecture middleware, including the CMO middleware, can be implemented by a SOA component such as the Enterprise Service Bus (ESB). This component is an important element in the SOA architecture and since it is used to allow services to interact to each other it is a good candidate to implement the functionality described by middleware 25.

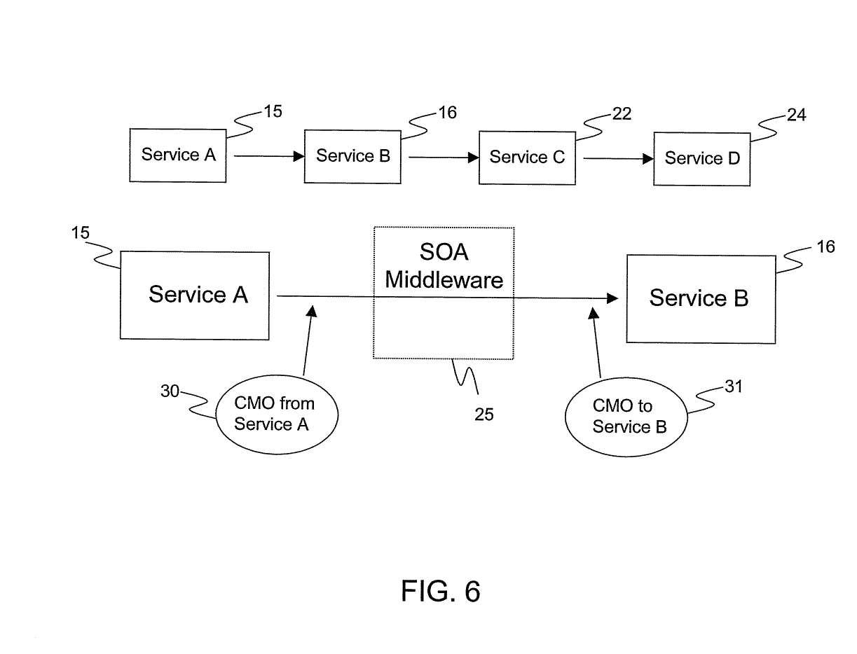

FIG. 6 is a flow diagram showing utilization of a CMO in an exemplary workflow. The workflow includes a service A 15, a service B 16, a service C 22, and a service D 24. A workflow session defines a running instance of the workflow. During a workflow session a media passes for transformation processes as it goes through the sequence of services defined in the workflow. The middleware layer 25 maintains for the entire session the information about the media being processed including new representations that are created as a result of interaction with the services. A middleware 25 generates a CMO 31 to service B 16. The middleware 25 may use the CMO 30 as the model to create CMO 31 or create it from scratch. Another alternative is to use a pre-defined template CMO as a model.

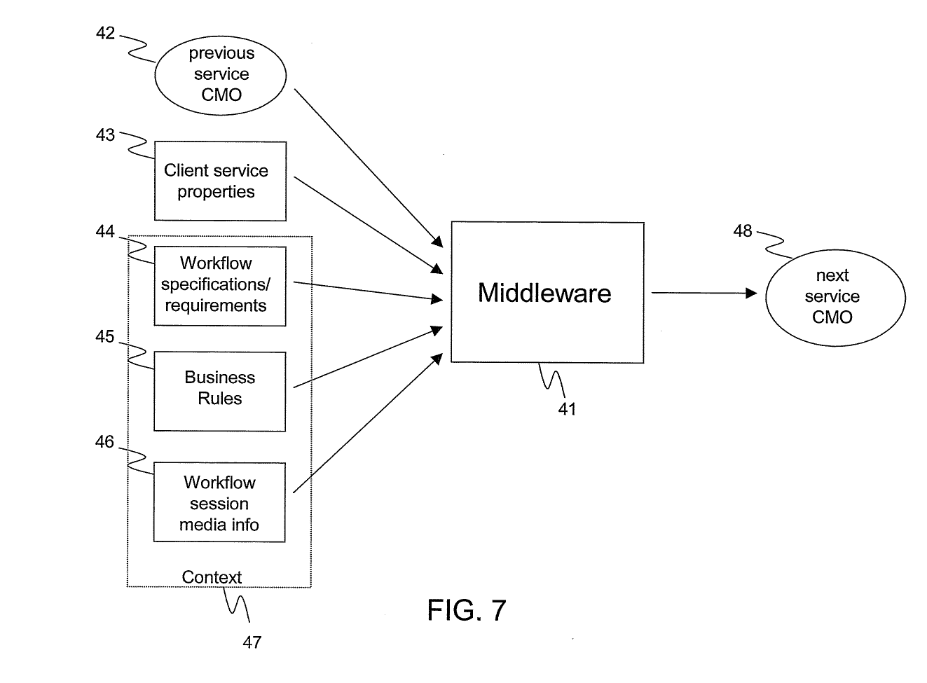

FIG. 7 is a flow diagram illustrating an exemplary method for creating a next service CMO 48. This next service CMO may represent, for example, the CMO 31 to service B 16 shown in FIG. 6. Returning to FIG. 7, a previous service CMO 42, service properties 43, workflow specifications/requirements 44, business rules 45 and workflow session media info 46 represent potential inputs to a CMO middleware 18. Workflow specifications/requirements 44, business rules 45 and workflow session media info 46 are part of the Context 47 in which the media is going to be processed by the next service. The previous service CMO 42 may represent the CMO 30 from service A 15 (FIG. 6). Based upon one or more of these potential inputs, the CMO middleware 18 (FIG. 7) generates the next service CMO 48.

The capabilities of the present invention can be implemented in software, firmware, hardware or some combination thereof As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention

While the preferred embodiment to the invention has been described, it will be understood that those skilled in the art, both now and in the future, may make various improvements and enhancements which fall within the scope of the claims which follow. These claims should be construed to maintain the proper protection for the invention first described.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for processing a media at run-time comprising:
generating a media object to represent the media by dynamically defining one or more media object properties and operations available to a media client;
communicating said media object to a media client;
dynamically defining an action associated to a requested operation in response to an operation request from the media client and
implementing the action for the requested operation.

2. The method of claim 1 wherein said dynamically defining one or more media object properties and operations is based on properties of the media client and the context wherein the media client received the media object.

3. The method of claim 1 wherein said dynamically defining an action is based on properties of the media client and the context wherein the media client requested the operation.

4. The method of claim 1 wherein a result of implementing the action is communicated to the media client.

5. The method of claim 1 further comprising updating the media object as a result of implementing the action.

6. The method of claim 1 wherein an action associated to a media operation can include a plurality of operations executed either locally at the media client or remotely.

7. The method of claim 6 wherein execution of the plurality of operations is handled by a workflow engine.

8. A computer program product comprising a storage medium readable by a processing circuit and storing instructions for execution by the processing circuit for facilitating a method for processing a media at run-time comprising:
generating a media object to represent the media by dynamically defining one or more media object properties and operations available to a media client;
communicating said media object to a media client;
dynamically defining an action associated to a requested operation in response to an operation request from the media client and
implementing the action for the requested operation.

9. A system for processing rich media at run-time comprising:
at least one media object generation component for dynamically creating a media object comprising media object information to represent the media, for sending selected media object information to at least one media client, and for dynamically defining an action associated to a requested operation in response to an operation request from the media client; and
at least one media container at a media client for receiving selected media object information from a media object generation component and for requesting at least one operation on said media based on the selected media object information.

10. The system of claim 9 wherein the at least one media object generation component dynamically defines the operations and properties of said media to be included in the selected media object information for a particular media client.

11. The system of claim 9 wherein said at least one media object generation component is located at an Enterprise Service Bus (ESB).

12. The system of claim 11 wherein a plurality of services is registered with the ESB for performing operations on media objects.

13. The system of claim 9 wherein the at least one media object generation component stores at least one media object for media and dynamically changes media object information in response to an operation request.

14. The system of claim 9 further comprising a workflow engine for execution of a plurality of operations.
